(19) United States
(12) Patent Application Publication
(10) Pub. No.: US 2010/0024530 A1
(43) Pub. Date: Feb. 4, 2010

(54) Lateral Flow Devices

(76) Inventor: Robert E. Hopkins, II, Scituate, MA (US)

Correspondence Address: GREENBERG TRAURIG, LLP, ONE INTERNATIONAL PLACE, 20th FL, ATTN: PATENT ADMINISTRATOR, BOSTON, MA, 02110, US

(21) Appl. No.: 12/511,191

(22) Filed: Jul. 29, 2009

Related U.S. Application Data
(60) Provisional application No. 61/084,521, filed on Jul. 29, 2008.

(51) Int. Cl. G01N 1/10; G01N 1/00

(52) U.S. Cl. 73/64.56; 73/863.23

(57) ABSTRACT

The embodiments disclosed herein relate to diagnostic products, and more particularly to lateral flow devices for detecting, for example, infectious diseases, molecules derived from infectious agents, and toxic substances. In an embodiment, a lateral flow device includes a top portion including a self-sealing test sample port and a self-sealing test reagent port; a bottom portion including a channel sufficiently designed to hold a lateral flow test strip; a test sample well sufficiently designed to accept and filter components of a test sample; a test reagent well sufficiently designed to accept components of a test reagent; and a tilting frame sufficiently designed to press the test reagent well against the lateral flow test strip while simultaneously lifting the test sample well from the lateral flow test strip.

### RELATED APPLICATIONS

This application claims the benefit of and priority to U.S. Provisional Application Ser. No. 61/084,521, filed Jul. 29, 2008, the entirety of this application is hereby incorporated herein by reference.

### FIELD

The embodiments disclosed herein relate to diagnostic products, and more particularly to lateral flow devices for detecting, for example, infectious diseases, molecules derived from infectious agents, and toxic substances.

### BACKGROUND

Lateral flow tests are primarily immunochromatographic assays that are also called lateral flow tests, or strip tests. Conventionally, lateral flow tests are performed using a plastic strip that is coated on one side with a chromatography material such as nitrocellulose. Any fluid contacting one end of the coating passes through the remaining portion of the coating to the opposite end of the strip. The mechanism of fluid transfer through the strip is called capillary flow. The strip can be lined transversely (striped) with immunological reagents such as antibodies or antigens that are dried on the chromatography material. Upon adding a biological fluid, such as plasma, as a test sample to one end of the strip, the contents of the fluid can pass down the coating and react, immunologically, with the stripes on the chromatography material. A color marker which reacts with the captured substances or molecules (analytes) from the sample then added to the coated side of the strip and causes a colored transverse stripe to appear. Unidirectional flow through the chromatography coating is assured by placing absorbent pads for addition of reagents and absorption of fluid passing through the chromatography material at each end of the test strip.

### SUMMARY

According to aspects illustrated herein, there is provided a lateral flow device that includes a top portion including a self-sealing test sample port and a self-sealing test reagent port; a bottom portion including a channel sufficiently designed to hold a lateral flow test strip; a test sample well sufficiently designed to accept and filter components of a test sample; a test reagent well sufficiently designed to accept components of a test reagent; and a tilting frame sufficiently designed to press the test reagent well against the lateral flow test strip while simultaneously lifting the test sample well from the lateral flow test strip.

According to aspects illustrated herein, there is provided a lateral flow device that includes a tubular hollow housing having a proximal end, a distal end, and a longitudinal axis therebetween sufficiently designed to hold a lateral flow test strip; a first plug sufficiently designed to seal the distal end of the tubular hollow housing; and a second plug sufficiently designed to seal the proximal end of the tubular housing, wherein the second plug includes an armature extension comprising: a sample well and micro-filter sufficiently designed to accept and filter components of a test sample; and a cut out open area sufficiently designed to deliver components of a test reagent onto the lateral flow test strip.

According to aspects illustrated herein, there is provided a method for testing a sample that includes providing a lateral flow device sufficiently designed to hold a test strip; dispensing a measured amount of the sample through a self-sealing sample port of the lateral flow device and into a sample well of the lateral flow device, wherein the sample is composed of a fluid specimen, and wherein the measured amount is about 200 microliters or less; wetting the test strip with the fluid specimen component of the sample; and dispensing up to about 200 microliters of a test reagent after a specified period of time through a self-sealing test reagent port of the lateral flow device such that the test reagent wets the test strip, wherein the test reagent flows laterally through the test strip causing analytes in the sample to flow in a direction of at least one test area and a control area on the test strip.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1 shows a perspective view of an embodiment of an assembled lateral flow test device of the present disclosure having a lateral flow test strip.

FIG. 2 shows a top view of the assembled lateral flow test device of FIG. 1.

FIG. 3 shows a cross-sectional view of the assembled lateral flow test device of FIG. 2 taken along line A-A.

FIG. 4 shows a side view of the assembled lateral flow test device of FIG. 1.

FIG. 5 shows an end view of the assembled lateral flow test device of FIG. 2 as viewed from line B-B.

FIG. 6A shows a perspective view of an embodiment of a tubular lateral flow test device of the present disclosure.

FIG. 6B shows a perspective view of the tubular lateral flow test device of FIG. 6A with a positive control stripe visible.

FIG. 6C shows a perspective view of the tubular lateral flow test device of FIG. 6A with a positive test stripe and a positive control stripe visible.

FIG. 6D shows a side cross-sectional cut-away view of the tubular lateral flow test device of FIG. 6A.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

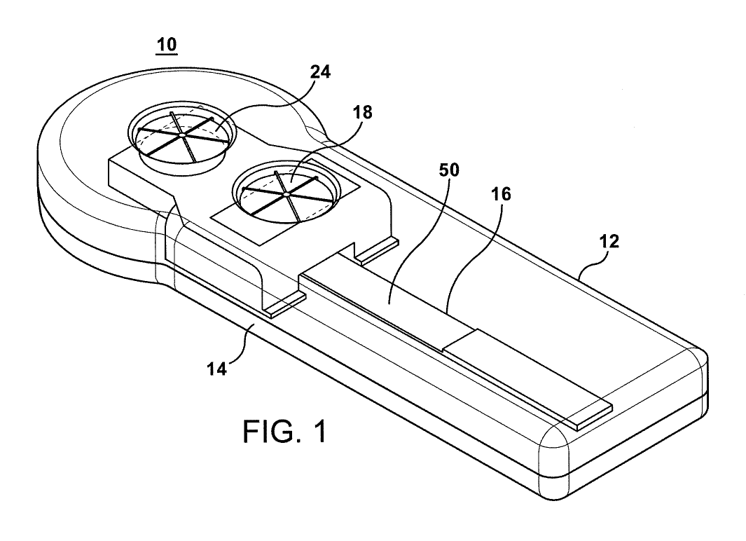

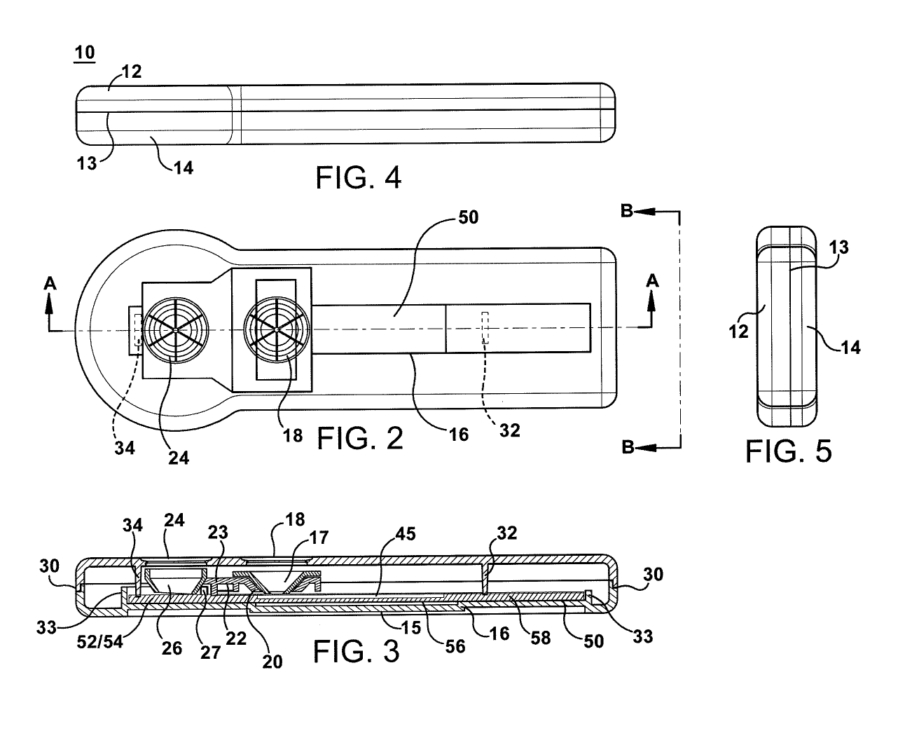

FIG. 1 in conjunction with FIG. 4 shows an embodiment of an assembled lateral flow test device 10 of the present disclosure having a top portion 12 including a self-sealing test sample port 18 and a self-sealing test reagent port 24, and a bottom portion 14 including a channel 16 sufficiently designed to hold a lateral flow test strip 50. As illustrated in the cross-sectional view of the device 10 in FIG. 3, when the top portion 12 and the bottom portion 14 are closed, the top portion 12 and the bottom portion 14 significantly overlap and are held together by friction at interlocks 30 to form an essentially waterproof, aerosol-proof union or seal 13 (see, for example, FIG. 4 and FIG. 5). In an embodiment, the assembled parts of the lateral flow test device 10 of the present disclosure are tightly sealed by the interlocking interface 30 to prevent leakage of test sample, reagents or other materials from the device 10 during handling, test preparation, testing, use and disposal. In an embodiment, the assembled device 10 is fabricated from a clear polymer top portion 12 and a clear polymer bottom portion 14 that encases the lateral flow test strip 50, the lateral flow test strip 50 prepared separately. In an embodiment, the lateral flow test strip 50 includes a test reagent pad 52 which covers an underlaying conjugate pad 54 containing detection conjugate, a nitrocellulose (NC) coated portion 56 on the test strip 50 with at least one capture binding, or test stripe, and a terminal absorbent pad 58.

The clear polymer, for purposes of this detailed description, shall be represented as the thermal plastic polypropylene (“plastic”) which is a transparent plastic that can be formed into the refined components of the device 10 by injection molding. The clear nature of the device 10 allows visual confirmation that all components parts of the device 10 are in place at manufacture. The clear top portion 12 of the device 10 is transparent which allows accurate observation by unaided vision of: addition of test sample, test reagents and all phases of the test reaction (e.g., the activation of the test, the proper function of the test and the use of either vision, light transmission or trans-illumination of the device 10 to read test results). Thus, failure to perform the test procedures properly, component failure or other malfunction can be easily observed. The transparent top portion 12 of the device 10 also allows test results to be observed immediately, or scanned with a light detection instrument, or other device directly through the plastic. The top portion 12 of the device 10 can also be tapered to reduce the overall top to bottom space over the NC coated portion 56 on the test strip 50 and the absorbent pad 58 which allows insertion of that portion of the device 10 into an optical reading and recording instrument. Such instrument could read and record light absorption, optical density, fluorescence emission, calorimetric light emission, or other spectrographic light emission by direct light transmission or trans-illumination of the device 10. The enclosed, clear nature of the top portion 12 of the device 10 allows safe handling and observation of the test and control stripe reactions which are the objective of the test. The ability to observe sequential functions of the device 10 and reactions between the test sample and test reagents during testing represent a major improvement over existing lateral flow devices. The device 10 contains components that perform specific functions in a stepwise fashion to produce a sensitive and accurate test result. The clear polymer design of the device 10 allows maximizing the number of test stripes and control stripes to permit a larger array of tests. Having one test stripe and one control stripe in a test is called singleplex testing. Having multiple test stripes and a control stripe in one device is called multiplex testing. For instance, with current lateral flow designs using opaque plastic the test observation portal has to be molded or cut and varies with different devices thus allowing only singleplex or limited multiplex testing with a control stripe. In an embodiment, the clear polymer of the device 10 of the present disclosure requires no test observation portal to be created thus allowing unlimited singleplex or multiplex analyte testing with a control stripe. In an embodiment, the transparent clear polymer is manufactured from a material that can magnify the stripes to facilitate the test to be read by the unaided eye.

As best illustrated in FIG. 1 and FIG. 2, the self-sealing test sample port 18 is cut or molded into the top portion 12 of the device 10. In an embodiment, the test sample port 18 comprises four or more radial plastic leaves that are self-sealing. In an embodiment, the four or more radial plastic leaves are formed into a circular shape. The diameter of the test sample port 18 ranges between approximately one (1) cm to two (2) cm, or more. The leaves form a substantially flat surface when not in use. Each leaf is separated from adjoining leaves by a radial slit approximately one (1) to approximately two (2) 1000^{ths} of an inch that penetrates the full thickness of the plastic top portion 12. This width of full thickness cut in the plastic is generally impenetrable to aqueous liquids or aerosols due to the hydrophobic nature of the plastic. When the test sample port 18 is used, a dispensing device such as a pipette tip, capillary tube, hypodermic needle or tip of some other form of dispensing device is pushed into the center of the test sample port 18. The pressure of the dispenser depresses the leaves opening the center of the test sample port allowing the test sample dispenser to be introduced into the device 10. The test sample is then dispensed, which typically takes seconds. When the dispensing device is removed, the memory of the plastic leaves causes them to return to their original position and form the original substantially flat surface, thereby re-sealing. As the test sample dispenser is removed from the device 10 the closing of the leaves causes any test sample droplets or residue to be dispensed into the device 10. This self-sealing array of the leaves re-establishes the hydrophobic nature of the port 18 and renders the port 18 waterproof and aerosol proof. The sealed sample port 18 increases the stability of the reagents and test by protecting the contents of the device 10 from contamination from airborne particles or droplets.

As best illustrated in FIG. 2, the bottom portion 14 of the device 10 includes the channel 16 that accepts the lateral flow test strip 50. In an embodiment, the lateral flow test strip 50 is an industry standard lateral flow test strip of approximately 60 mm by 5 mm. In an embodiment, the lateral flow test strip 50 is a larger strip of approximately 72 mm or more and about 8 mm wide and variable thickness. Accepting different lengths, widths and thickness of lateral flow test strips allows flexibility to maximize the number of test stripes on a strip to produce a multiplex test that can be striped and detect, for example, six (6) or more different agents and a control agent. Accepting longer lateral flow test strips allows optimum flexibility in developing test strips with larger numbers of test and control stripes. The transparent material of the bottom portion 14 allows light to be directed from beneath the device 10 which trans-illuminates the lateral flow test strip 50 and allows enhanced visual or light transmission readout of reactions at individual test stripes. The top portion 12 of the device 10 includes two pressure bars 32 and 34 that press down on the lateral flow test strip 50 to secure the lateral flow test strip 50 in a proper position in the channel 16. The pressure bars 32 and 34, while in contact with the lateral flow test strip 50, are separated by approximately 0.5 mm to approximately 1.5 mm from the channel 16 beneath the strip 50 so that test strips of different thicknesses can be gently held in place and not compressed in the channel 16. This gentle pressure securing the lateral flow test strip 50 permits test sample and/or test reagents to flow evenly through the test lateral flow test strip 50 facilitating optimum fluid dynamics between test stripes where target analytes are immobilized and react with test reagents. As best illustrated in FIG. 3, the channel 16 has a depressed area 15 approximately 0.5 mm deep beneath the center of the NC coated portion 56 on the test strip 50. This depressed area 15 prevents test sample and reagents from flowing over the edges and beneath the lateral flow test strip 50. The sidewalls of the channel 16 are about 1 mm to about 3 mm high at both ends of the lateral flow test strip 50 so that spillage or leakage cannot occur into the end spaces in the device 10 adjacent to the channel 16. The plastic composition of the sidewalls is hydrophobic causing beading of test sample or test reagents and absorption by the NC coated portion 56 on the test strip 50.

The thickness of the test reagent pad 52 and of the absorbent pad 58 can vary but sufficient space between the edge of pressure bars 32 and 34 and the bottom of the channel 16 to allow securing the test strip 50 in place without impeding flow dynamics. The capability of accepting a lateral flow test strip 50 of different lengths and widths between about 60 mm and about 72 mm or greater in length and about five (5) mm to about eight (8) mm or greater in width is unique to the device 10. A lateral flow test strip that is longer than the standard 60 mm length is secured by two wedges (not shown) located in front of the absorbent pad pressure bar 32. These wedges protrude laterally into the channel 16 by approximately 0.5 mm and hold the lateral flow test strip in place by friction. These friction wedges are located approximately 60 mm from a test reagent well end of the channel.

A test sample well 20 is sufficiently designed to accept and filter components of a test sample. The test sample well 20 includes a filter insert 17, and is an integral part of a tilting frame 22, as illustrated in FIG. 3. In an embodiment, the test sample well 20 is part of the tilting frame 22. In an embodiment, the test sample well 20 is mounted on the tilting frame 22. The top of the filter insert 17 may have a small orifice with a lip to allow containment of the test sample dispensed into the test sample well 20 which prevents accidental spilling or loss of test sample during the dispensing procedure. In an embodiment, the filter insert 17 used to exclude cells, debris or interfering substances, is fabricated from a material selected from the group consisting of polymers, glass, porous metals or other suitable materials that produce uniform filter pore size and filtration properties. The filter insert 17 for the test sample well 20 can be fabricated from a material that can snap into, be affixed with adhesive, or attached by other means to the test sample well 20.

The test sample well 20 and filter insert 17 receives and filters a volume of test sample that can range from approximately 30 μL to more than 200 μL. In an embodiment, the test sample well 20 and filter insert 17 have a capacity of 0.2 ml or more. The filter material removes cells, debris and interfering substances from the test sample and then transfers the purified test sample directly to the lateral flow test strip 50. In an embodiment, the pore size of the filter 17 material is about 1.2 microns+/−1 micron. In an embodiment, the test sample well 20 is fabricated in a “V” shape that is open at the bottom such that the filter 17 material has direct contact with the lateral flow test strip 50 in transverse, linear fashion. The test sample passes to the bottom of the “V” shape, through the filter insert 17 and transfers onto the test strip 50. This transverse, linear contact transfers a stripe of purified test sample about 1.0 mm to about 3.0 mm in width and transects the entire width of the lateral flow test strip 50. As purified test sample continues to be transferred, depending upon the total test sample volume and duration of contact, the flow of test sample begins to flow in the direction of the absorbent pad 58. In an embodiment, the absorbent pad 58, which causes purified test sample and test reagent liquids to flow laterally across the lateral flow test strip 50, has an absorbent volume that exceeds the combined volume of the purified test sample and reagent volume. Absorbing this combined volume prevents excess retrograde flow after completion of the test. The transecting stripe of purified test sample ensures even distribution onto and optimum flow through the length of the NC coated portion 56 on the test strip 50. The NC coated portion 56 on the test strip 50 is where the test stripes are located and the target analytes are immobilized and detected by reaction with test reagents. The optimization of flow of purified test sample prevents shunting of purified test sample or test reagents which causes variability in immobilization of target analytes, reaction with test reagents and detection. This pattern of uniform transfer of purified test sample and test reagents, optimum flow dynamics through the NC coated portion 56 on the test strip 50, and optimized reaction at the test stripes allows detection of target analytes with improved selectivity, limits of detection and sensitivity.

As best illustrated in FIG. 1 and FIG. 2, the self-sealing test reagent port 24 is cut or molded in the top portion 12 of the device 10. The test reagent port 24 is separate from the test sample port 18. In an embodiment, the test reagent port 24 is a pattern of radial leaves. In an embodiment, the test reagent port 24 comprises four or more radial plastic leaves that are self-sealing. In an embodiment, the four or more radial plastic leaves are formed into a circular shape. A test reagent dispenser is pressed downward on a center portion of the test reagent port 24 leaves. The pressure of the reagent dispenser opens the leaves allowing the test reagent to enter into the device 10. After the test reagent is dispensed into a test reagent well 26 the test reagent dispenser is removed from the device 10. The test reagent well 26 is sufficiently designed to accept components of the test reagent. When the test reagent dispensing device is removed, the memory of the plastic leaves causes them to return to their original position and form the original substantially flat surface, thereby re-sealing. During the process of re-sealing the leaves of the test reagent port 24 remove any hanging drop residue from the test reagent dispenser and upon completion of re-sealing assures the capability to contain all liquids and/or aerosols inside the device 10. Re-sealing of the test reagent port 24 also assure that no contamination of the device 10 by airborne particles or droplets.

The test reagent well 26 can include a filter insert, but filtering test reagents is not usually necessary for proper function of the test reagent if a test reagent pad 52 is used. In an embodiment, the test reagent well 26 is part of the tilting frame 22. In an embodiment, the test reagent well 26 is mounted on the tilting frame 22. In an embodiment, the test reagent well is separate from the test sample well 20 on the opposite end of the tilting frame. In an embodiment, the test reagent well 26 is initially separated from the test reagent absorbent pad 52 which covers an underlying conjugate pad 54 which connects to the test strip 50 beneath the test sample well 20 and filter insert 17.

The test reagent well 26 mounted on the tilting frame 22 is partly enclosed on both sides by two vertical flanges (one on either side, not shown) that are part of the bottom portion 14 of the device 10. These vertical flanges partly enclose the lateral sides of the test reagent well 26 and are approximately three (3) to approximately five (5) mm extensions of the raised lip front 27 of the test strip channel 16. These vertical flanges are tapered very slightly so as to become narrower in width near the base of the strip channel 16. In an embodiment, the test reagent well 26 makes contact with the vertical flanges on both sides of the strip channel 16. In an embodiment, as the test reagent well 26 located between these two vertical flanges is depressed downward towards the test reagent pad 52 in the strip channel 16, the lateral sides of the test reagent well increase their contact with the two vertical flanges and lock the test reagent well 26 in place when it contacts the test reagent pad 52 by friction. When fully depressed, to a depth of approximately 0.2 to approximately 0.5 mm the test reagent well 26 is locked down onto the test reagent absorbent pad 52 so that test reagents are absorbed quickly and delivered directly to the conjugate strip 54 underneath and to the test strip 50 beyond the conjugate strip 54.

The tilting frame 22 connecting the test sample well 20 and the test reagent well 26 has a pivot point (or fulcrum) 23 that is located beneath the center of the frame 22 and which rests on the lateral flow test strip 50. The pivot point 23 (or fulcrum) is located approximately midway between the test sample well 20 and the test reagent well 26. In the pretest position, the pivot 23 rests on the lateral flow test strip 50 and the test sample well 20 with filter insert 17 contacts the lateral flow test strip 50 over the initial 3 mm to 5 mm of the NC coated portion 56 on the test strip 50. As the test reagent dispenser is introduced into the device 10, the tip of the dispenser depresses an armature (lever) inside the test reagent well 26 and forces the test reagent well 26 downward between the two vertical flanges lateral to the sides of the test reagent well 26. This downward force closes the gap between the bottom of the test reagent well 26 and the test reagent pad 52 until these two components make contact. Depressing the lever and test reagent well 26 transfers pressure across the pivot point 23 (fulcrum) to the opposite side of the filter frame 22 which causes the test sample well 20 and filter insert 17 to lift and separate from contacting the lateral flow test strip 50. Separation of the test sample well 20 and filter insert 17 from the lateral flow test strip 50 assures test reagents will not flow retrograde into, adsorb or absorb on the filter insert 17 in the test sample well 20. The separation of the test sample well 20 from the lateral flow test strip 50 directs approximately 100% flow of all purified test sample and test reagents through the NC coated portion 56 on the test strip 50, across the test and control stripes and efficient absorption by the terminal absorbent pad 58. Optimum fluid dynamics produces even flow and efficient utilization of test reagents. A space 45 beneath the lateral flow test strip 50 further prevents test sample and/or reagents from flowing off the lateral margins of the test strip 50. The tilting frame 22 is sufficiently designed to press the test reagent well 26 against the test reagent absorbent pad 52 while simultaneously lifting the test sample well 20 from the lateral flow test strip 50.

If the test reagent well 26 includes a filter insert, the filter insert can be fabricated from a material having the same material or a different material then the test sample filter insert 17. The filter can snap into, be affixed with adhesive, or attached by other means into the test reagent well 26. If the test reagents are previously purified and a filter is not needed, the test reagent can be transferred directly to the test reagent pad 52.

The test reagent well 26 has a volume capacity of approximately 0.3 ml or more, which exceeds the volume of test reagent needed to perform the test. This test reagent well 26 receives a volume of test reagent that may range from approximately 100 μL to more than 200 μL. The test reagent dispensed into the test reagent well 26 is absorbed almost immediately into the test reagent pad 52, which transfers test reagent to the conjugate pad 54 thereby re-suspending the conjugate, which in turn transfers test reagent and re-suspended conjugate to the test strip 50. The transfer of conjugate and test reagent to the test strip 50 initiates the analyte detection phase of testing.

The effect of dispensing test sample onto the test strip 50, then separating the test sample well 20 and filter insert 17 from the test strip 50 and subsequently dispensing test reagents through a separate test reagent port 26 separates the flow of purified test sample and test reagents into two phases of liquid flow. Separation into two phases of flow assures there can be no accidental, significant contact, mixing or reaction of purified test sample and test reagents before reaching test stripes where target analytes in the purified test sample are captured on the test strip 50. Prevention of reaction before the test stripes ensures optimum detection, selectivity and sensitivity of the lateral flow test.

When the test sample and test reagent fluids reach the absorbent pad 58, the combined fluids wet the absorbent pad 58 and re-suspends disinfectant and/or chemical inactivation substance that are dried onto the absorbent pad 58. Activation of these disinfecting and/or chemical inactivating substances causes the agent to migrate back through the lateral flow test strip 50 by diffusion gradient while simultaneously producing a vapor that decontaminates the unit for disposal. This disinfecting and/or chemical inactivating mechanism allows the device 10 to be safely used for detecting live infectious agents (bacteria, fungi, protozoa, sporozoa) or viruses in biological fluids. The sealed nature of the device 10 with the liquid and aerosol proof re-sealing ports 18 and 24 and sealed joints of the assembled top portion 12 and the bottom portion 14 protects the tester from accidental exposure to contamination with such infectious or hazardous agents. The safety features of the test also allow testing under field conditions using minimum personnel protective equipment—gloves, mask and eye glasses.

In an embodiment, the top portion 12, the bottom portion 14, the tilting frame 22 with test sample well 20 and test reagent well 26 of the device 10 are fabricated from a clear thermal plastic polymer that possesses hydrophobic properties. Such a test device 10 could also be used to test for chemical agents that are in aqueous fluids that would be compatible with the polymer fabrication material. In an embodiment, the top portion 12, the bottom portion 14, the tilting frame 22 with test sample well 20 and test reagent well 26 of the device 10 are fabricated from other polymeric or fabrication materials that might be clear but possess lipophobic properties. In this embodiment, the test device 10 could be used for detecting analytes that are soluble or suspended in lipid, non-aqueous fluids such as alcohols, ethers, oils and other organic liquids.

In an embodiment, the device 10 of the present disclosure improves safety of handling and testing. In an embodiment, the device 10 of the present disclosure uses a disinfecting and/or chemical inactivation mechanism that ensures safe disposal after the completion of testing and safety of archiving of the used device 10. These features make a strip test quick, safe and otherwise ideal for applications such as rapid field testing, general laboratory testing without containment and point of care testing for immunological or chemical agents. The strip can also be used to detect organic or inorganic chemical agents in the field, laboratory or point of care settings. This form of test provides a reliable method of testing in developing countries where other laboratory test methods are not available.

In an embodiment, the present disclosure provides a clear polymer lateral flow device 10 having an internal channel 16 for accepting a lateral flow test strip 50 of varying lengths, widths and thicknesses. The clear polymer nature of the device 10 allows visual, direct light measurement or trans-illumination light measurement for determination of reactions. The lateral flow device 10 includes a self-sealing test sample port 18 and a self-sealing test reagent port 24. The lateral flow device 10 includes a tilting frame 22 component for separately dispensing various volumes of components of a test sample into test sample well 20 and components of a test reagent into a test reagent well 26 that flow separately onto a lateral flow test strip 50. The lateral flow device 10 includes a test sample well 20 with filter insert 17 that is sufficiently designed to removes cells, debris and interfering substances that improves the quality of the test sample. The test sample well 20 and filter insert 17 applies a transverse stripe of sample to a specific area of the lateral flow test strip 50. The tilting frame 22 separates the test sample well 20 and filter insert 17 from the lateral flow test strip 50 when a test reagent dispenser is introduced into the test reagent well 26. The lateral flow device 10 includes a seal 30 between the two halves of the device 10 that is water and aerosol proof. The lateral flow device 10 is sealed and safe for testing infectious agents and/or hazardous substances. The lateral flow device 10 includes an internal disinfecting or chemical neutralization system that renders the device 10 safe for disposal.

The filter insert 17 mounted in the test sample well 20 can have a small orifice at the top of the filter insert 17 or lip on the filter insert 17 to prevent accidental loss of dispensed test sample and/or spilling test sample inside the device 10. This small orifice or lip ensures the test sample (which may contain an infectious agent, hazardous agent or contaminant) is maximally contained and filtered onto the test strip 50. This feature would be fabricated into the filter insert 17 or molded as part of the test sample well 20 of the device 10.

In an embodiment, a method for detecting the presence of at least one analyte in a test sample of a subject includes the following steps, not necessarily in the order provided. A lateral flow device 10 of the present disclosure is provided. The test sample (blood or other biological fluid having various components, including a fluid phase) is obtained from storage or collected directly from the test subject. A volumetric measured amount (up to about 200 μL) or a specific number of drops can be dispensed through the test sample port 18 of the device 10 using a pipette, capillary tube or syringe device. The filter insert 17 in the test sample well 20 collects the test sample and is sufficiently designed to separate any cells, debris and interfering substances from the test sample, allowing the fluid phase to flow through the filter insert 17 and transfer onto the NC coated portion 56 on the test strip 50 by direct contact. This direct contact facilitates the migration of purified test sample and any target substances or molecules (analytes) to the test stripes where such substances are immobilized on the lateral flow test strip 50. After a specified time for transfer and migration of purified test sample, typically 60 seconds or longer, an amount up to about 200 μL of test reagent is added to the test reagent well 26 through the test reagent port 24. Upon introduction of the test reagent dispenser, the tilting frame 22 transfers the downward pressure through the pivot/fulcrum 23 which lifts the test sample well 20 and filter insert 17 from contact with the lateral flow test strip 50. The test reagent well 26 locks in place and the test reagent dispensed is absorbed into a test reagent pad 52 with a conjugate pad 54 beneath which re-suspends the conjugate, for example, and transfers conjugate and test reagent uniformly to the lateral flow test strip 50. The test reagent and conjugate flow laterally through the test strip 50 to the test stripes. At the test stripes any immobilized target substances combine with the colloidal gold to allow detection by direct visual observation or by light emission measurement using an instrument. The combined fluids from the purified test sample continuously flow to an absorbent pad 58 at the terminal portion of the test strip 50. The reaction between any target substance in a purified test sample and colloidal gold marker might take between 5 and 15 minutes to be optimally detectable by unaided vision, or sooner with light measuring instrument. A visible control stripe indicates the assay was performed correctly and a visible test stripe indicates presence of the target substance. The absence of a stripe at the test stripe indicates the target substance was not present in the test sample.

The lateral flow device 10 can be used for on-site or in the field testing for infectious agents in people and animals. The lateral flow device 10 can be used for detecting at least one analyte in a test sample. As used herein, the term “analyte” generally refers to a substance or molecule to be detected. For instance, analytes include, but are not limited to, antigenic substances, haptens, antibodies, and combinations thereof. Analytes include, but are not limited to, toxins, organic compounds, proteins, peptides, microorganisms, amino acids, nucleic acids, hormones, steroids, vitamins, drugs (including those administered for therapeutic purposes as well as those administered for illicit purposes), drug intermediaries or byproducts, bacteria, virus particles and metabolites of or antibodies to any of the above substances. In an embodiment, the analyte is an antibody or antigen of infectious agents, hormone, small biological molecule, metabolite or other naturally occurring biological substance that can be detected in blood or other biological fluids. The test can be used to detect exposure to foreign biological or chemical substances that might be detectable in blood or biological fluid. The device 10 may also be used to detect substances in non-biological fluids that are aqueous, alcohol, or lipid soluble providing the test sample is compatible with the polymeric composition of the device 10. The device 10 could also be used safely with radioactive or other hazardous substances attached to the target analyte. The device 10 is not limited to use with optically visible calorimetric markers because the clear plastic top of the device 10 allows scanning of the test area on the stripe with devices such as a Woods Light for fluorescence, an optical density scanner, a gamma camera or other device that read and/or quantify a marker attached to at captured test analyte or control substance. The test might be used for environmental testing where a gas can be absorbed into a liquid, a fluid can be extracted from a solid source, a fluid can be filtered from solid matter, or other types of fluids can be obtained, extracted or otherwise produced. Examples of uses would include, but are not limited to, testing blood for analytes; testing saliva, cerebrospinal fluid, perilymph, urine, or cell extracts for analytes; testing a biological solution, suspension or mixture for contaminants; testing a chemical solution, suspension or mixture for contaminants; testing ground water for contaminants; testing a specific volume of air bubbled through an absorbent liquid for a contaminant; testing a radioactive labeled substance for radioactivity by test analyte capture.

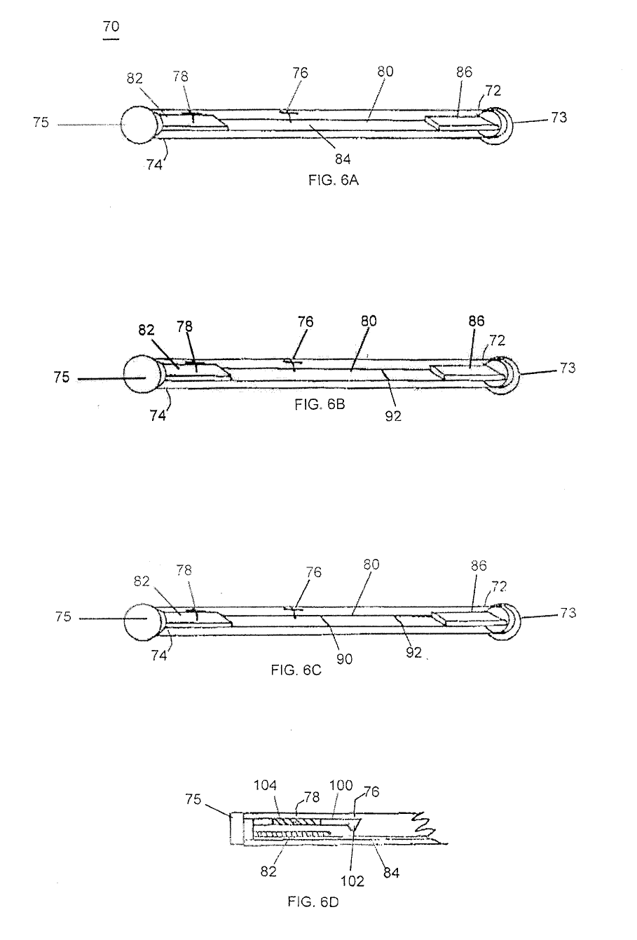

FIG. 6A, FIG. 6B, FIGS. 6C and 6D show an embodiment of a lateral flow device 70 of the present disclosure. The lateral flow device 70 includes a tubular hollow housing having a proximal end 74, a distal end 72, and a longitudinal axis therebetween sufficiently designed to hold a lateral flow test strip 80. In an embodiment, the tubular hollow housing is fabricated from a clear polymer that is flexible. The test strip 80 has a test reagent absorbent pad 82, a conjugate pad beneath (not shown), a nitrocellulose (NC) coated test area 84 and a terminal absorbent pad 86 to cause lateral flow. The NC coated test area 84 has one or more capture binding stripes, or test stripes 90, and a control stripe 92. FIG. 6A shows the lateral flow device 70 prior to use. The device 70 is assembled by inserting the lateral flow test strip 80 from either the distal end 72 or the proximal end 74 and then sealing the device 70 at both ends 72 and 74. In an embodiment, the device 70 has an internal diameter of approximately 6 mm to approximately 8 mm. This diameter can accommodate the width of the lateral flow test strip 80. In an embodiment, the distal end 72 of the device 70 is sealed with a plug 73, and the proximal end 74 of the device 10 is sealed with a plug 75. Plugs 73 and 75 may be heat sealed or solvent sealed in place, and may be fabricated from a plastic material.

The plug 75, secures the lateral flow test strip 80 in position at the proximal end 74 of the device 70, and includes an armature extension 100 (shown in FIG. 6D). The armature extension 100 includes a sample well 102 and micro-filter that extends into the hollow lumen of the device 70 and is sufficiently designed to accept and filter components of a test sample. In an embodiment, the armature extension 100 is fabricated from a flexible plastic material. The sample well 102 and micro-filter extends to a point directly over the NC coated test area 84 of the lateral flow strip 80. This is the location where the filtered test sample would be transferred to the lateral flow test strip 80. The sample well 102 and micro-filter can take the shape of a molded “V” sample well. In an embodiment, the micro-filter material is glued to the test sample well 102. The volumetric capacity of the “V” shaped sample well 102 with micro-filter 102 is approximately 50 μl. The tip of the “V” shaped sample well 102 with micro-filter 102 is open and does not touch the NC coated test area 84 of lateral flow test strip 80. After dispensing a micro-volume of test sample into the “V” shaped test sample well 102 with micro-filter the armature extension 100 can be manually moved (e.g., squeezed or pressed) through the tubular device 70 to depress the sample well 102 and cause the open end of the sample well 102 and tip of the micro-filter material to contact the NC coated test area 84 of the lateral flow test strip 80. Contact with the lateral flow test strip 80 allows filtered test sample to flow onto the test strip 80. In an embodiment, the device 70 can be used to test extremely small, micro-volume amounts of test sample (approximately 20 microliters to approximately 30 microliters, one drop) and use very small amounts of test reagent (approximately 50 microliters to approximately 70 microliters or more, two drops).

The armature extension 100 also includes a cut out open area 104 approximately 2 mm from the plug 75 that is about 2 mm to about 3 mm wide and about 5 mm long. The cut out open area 104 is sufficiently designed to deliver components of a test reagent onto the lateral flow test strip 80 The cut out open area 104 of the armature 100 directly overlays the test reagent pad 82 of the lateral flow test strip 80.

The tubular hollow housing of the device 70 includes a self-sealing test sample port 76 for test sample dispensing directly above the sample well 102 and micro-filter which overlays the NC coated test area 84, and a self-sealing test reagent port 78 for test reagent dispensing directly above the linear cut out area 104 in the arm 100 which overlays the test reagent absorbent pad 82. The ports 76 and 78 are full thickness laser, or instrument cuts through the tubular plastic material of the device 70. The cuts produce four leaves which hold the original tubular shape and their configuration in the tubular wall of the tubular device 70 by memory of the plastic polymer. The test sample port 76 and the test reagent port 78 will re-seal after a dispensing device for either a micro-volume test sample or test reagent is removed from the device 70. In an embodiment, the test sample port 76 and the test reagent port 78 comprises two or more radial plastic leaves that are self-sealing. In an embodiment, the two or more radial plastic leaves are formed into a circular shape. The diameter of the test sample port 76 and the test reagent port 78 can range between approximately one (1) cm to two (2) cm, or more. The leaves form a substantially flat surface when not in use. Each leaf is separated from adjoining leaves by a radial slit approximately one (1) to approximately two (2) 1000^{ths} of an inch that penetrates the full thickness of the tubular hollow housing. Test sample and test reagents are dispensed into the device by a micropipette tip, micro-capillary tube or hypodermic needle that are inserted into the lumen of the tubular device 70 through the test sample port 76, and the test reagent port 78, respectively.

In an embodiment, the tubular device 70 inserts temporarily into a plastic holder that can be held firmly in a tester's hand, or laid on a flat surface and held in a secure position. The use of a plastic holder is intended to protect the tester's hands from accidental exposure to potentially infective, hazardous or contaminated test sample during the dispensing of test sample and test reagents.

In an embodiment, 30 μl of test sample is dispensed through the test sample port 76 into the sample well 102 of the armature extension 100. The armature extension 100 is depressed by digital pressure through the tubular wall of the device 70 for approximately 60 seconds to allow test sample to transfer onto the test strip 80. During this period of time, the micro-volume sample (for example, 15 μl) is transferred to the lateral flow test strip 80 and any target analytes in the test sample migrate to the test stripes on the NC coated tested area 84. After the allotted period of time, digital pressure is released and the armature 100 lifts off the lateral flow test strip 80. Lifting of the armature 100 causes the transfer of test sample to cease. Transferred test sample then continues to migrate through the NC coated test area 84 to the lateral flow test stripes where target analytes are immobilized. If migration of the test sample is observed and does not reach the lateral flow test stripes, an additional 15 μl of test sample can be dispensed through the test sample port 76 into the sample well 102 in the armature extension 100. This additional test sample can enhance migration of test sample to the test stripe. When the test sample reaches the test stripes, test reagent is then dispensed through the test reagent port 78 through the cut out open area 104 in the armature extension 100 to the test reagent pad 82 beneath the armature extension 100. The test reagent then flows through the test reagent pad 82, re-suspending the conjugate in the conjugate pad beneath passing the re-suspended conjugate and test reagent onto the NC coated test area 84. The test reagent and re-suspended conjugate flow through the NC coated test area 84. Upon reaching the NC coated test area 84 the conjugate reacts with any immobilized analytes at the test stripes which allows the reaction to be detected by sight of by light detecting instrument.

FIG. 6B shows the tubular test device 70 having a positive control stripe 92 (visible) and a positive test stripe 90 (not visible) on the lateral flow test strip 80. The results indicate a properly performed lateral flow test procedure that did not detect the target analyte at the test stripe 90.

FIG. 6C shows the tubular test device 70 having a positive control stripe 92 (visible) and a positive test stripe 90 (visible) on the lateral flow test strip 80. The results indicate a properly performed lateral flow test procedure that was positive for the target analyte at the test stripe 90.

In an embodiment, the tubular test is performed by obtaining a test sample of blood or biological fluid obtained by an appropriate micro method, and dispensing between 20 microliters and 30 microliters (one drop) through the test sample port 76 into the filter insert beneath lining the sample well 102. Once the sample is dispensed into the filter insert, the tubular hollow housing is squeezed to depress the armature extension 100 inside and cause the filter insert tip to contact the lateral flow test strip 80. The armature extension 100 is depressed for approximately 60 seconds and is then released, which lifts the filter away from the test strip 80. Approximately 60 microliters to 120 microliters (two to four drops) of test reagent is then added through the test reagent port 78. The test reagent is directed carefully to drop through the cut out open area 104 in the armature extension 100 and onto the test reagent absorbent pad 82 on the test strip 80. The test is then activated.

A method for testing a sample includes providing a lateral flow device sufficiently designed to hold a test strip; dispensing a measured amount of the sample through a self-sealing sample port of the lateral flow device and into a sample well of the lateral flow device, wherein the sample is composed of a fluid specimen, and wherein the measured amount is about 200 microliters or less; wetting the test strip with the fluid specimen component of the test sample; and dispensing up to about 200 microliters of a test reagent after a specified period of time through a self-sealing test reagent port of the lateral flow device such that the test reagent wets the test strip, wherein the test reagent flows laterally through the test strip causing analytes in the sample to flow in a direction of at least one test area and a control area on the test strip.

A method for testing a sample includes providing a lateral flow device of the present disclosure; obtaining a test sample from a subject, the test sample including a fluid component; dispensing the test sample through the test sample port of the lateral flow device for placing the test sample in the test sample well of the lateral flow device, the test sample well including a filter insert capable of separating cells, debris and interfering substances from the fluid component of the test sample; transferring the fluid component of the test sample from the test sample well onto the lateral flow test strip of the lateral flow device by direct contact; dispensing test reagent through the test reagent port of the lateral flow device for moving the filter frame of the lateral flow device; lifting the test sample well and filter insert off of the lateral flow test strip; dispensing the test reagent onto the absorbent pad of the lateral flow device; transferring the test reagent substantially uniformly to the lateral flow test strip; flowing the test reagent laterally through the lateral flow test strip to re-suspend a colloidal gold marker reagent to an immobilization stripe on the lateral flow test strip.

All patents, patent applications, and published references cited herein are hereby incorporated by reference in their entirety. It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A lateral flow device comprising:
a top portion including a self-sealing test sample port and a self-sealing test reagent port;
a bottom portion including a channel sufficiently designed to hold a lateral flow test strip;
a test sample well sufficiently designed to accept and filter components of a test sample;
a test reagent well sufficiently designed to accept components of a test reagent; and
a tilting frame sufficiently designed to press the test reagent well against the lateral flow test strip while simultaneously lifting the test sample well from the lateral flow test strip.

2. The lateral flow device of claim 1 wherein the top portion and the bottom portion are fabricated from a clear polymer material.

3. The lateral flow device of claim 1 wherein the lateral flow test strip includes one of an internal disinfecting system or a chemical neutralization system that renders the device safe for disposal.

4. The lateral flow device of claim 1 wherein the self-sealing test sample port and the self-sealing test reagent port comprises four or more radial plastic leaves.

5. The lateral flow device of claim 1 wherein the test sample well is formed as part of the tilting frame.

6. The lateral flow device of claim 1 wherein the test reagent well is formed as part of the tilting frame.

7. The lateral flow device of claim 1 further comprising a vertical channel for locking the test reagent well.

8. The lateral flow device of claim 1 wherein the self-sealing test sample port is sufficiently designed to contain the test sample within the device.

9. The lateral flow device of claim 1 wherein the self-sealing test reagent port is sufficiently designed to contain the test reagent within the device.

10. A lateral flow device comprising:
a tubular hollow housing having a proximal end, a distal end, and a longitudinal axis therebetween sufficiently designed to hold a lateral flow test strip;
a first plug sufficiently designed to seal the distal end of the tubular hollow housing; and
a second plug sufficiently designed to seal the proximal end of the tubular housing, wherein the second plug includes an armature extension comprising:
a sample well and micro-filter sufficiently designed to accept and filter components of a test sample; and
a cut out open area sufficiently designed to deliver components of a test reagent onto the lateral flow test strip.

11. The lateral flow device of claim 10 wherein the tubular hollow housing is fabricated from a clear polymer.

12. The lateral flow device of claim 10 wherein the tubular hollow housing includes a self-sealing test sample port and a self-sealing test reagent port.

13. The lateral flow device of claim 12 wherein the self-sealing test reagent port is sufficiently designed to dispense the test reagent within the cut out open area of the armature extension, the cut out open area directly overlaying a test reagent absorbent pad on the lateral flow test strip.

14. The lateral flow device of claim 12 wherein the self-sealing test sample port is sufficiently designed to dispense the test sample into the sample well and micro-filter, the sample well and micro-filter directly overlaying a nitrocellulose coated area on the lateral flow test strip.

15. A method for testing a sample comprising:
providing a lateral flow device sufficiently designed to hold a test strip;
dispensing a measured amount of the sample through a self-sealing sample port of the lateral flow device and into a sample well of the lateral flow device, wherein the sample is composed of a fluid specimen, and wherein the measured amount is about 200 microliters or less;
wetting the test strip with the fluid specimen component of the sample; and
dispensing up to about 200 microliters of a test reagent after a specified period of time through a self-sealing test reagent port of the lateral flow device such that the test reagent wets the test strip, wherein the test reagent flows laterally through the test strip causing analytes in the sample to flow in a direction of at least one test area and a control area on the test strip.

16. The method of claim 15 wherein the sample well includes a filter insert sufficiently designed to accept and filter cells, debris and interfering substances from the fluid specimen of the sample.

17. The method of claim 15 wherein the lateral flow device further includes a test reagent well overlaying the test strip, the test reagent well sufficiently designed to accept components of the test reagent prior to wetting the test strip.

18. The method of claim 17 wherein the test reagent wets the test strip after pressing the test reagent well against the test strip.

19. The method of claim 16 wherein the lateral flow device further includes an armature extension comprising a cut out open area sufficiently designed to dispense the test reagent onto the test strip to wet the test strip.

20. The method of claim 19 wherein the fluid specimen component of the sample wets the test strip after moving the armature extension against the test strip.
